(19) United States
(12) Patent Application Publication
(10) Pub. No.: US 2017/0284112 A1
(43) Pub. Date: Oct. 5, 2017

(54) Method for Constructing Structure Framework with Graduated Tracks and Studs

(71) Applicant: Ukshin Elshani, Bowie, MD (US)

(72) Inventor: Ukshin Elshani, Bowie, MD (US)

(21) Appl. No.: 15/476,811

(22) Filed: Mar. 31, 2017

Related U.S. Application Data
(60) Provisional application No. 62/315,724, filed on Mar. 31, 2016.

(51) Int. Cl. E04G 21/18; G01B 5/14; G01B 5/16; E04G 17/14

(52) U.S. Cl. CPC E04G 21/1841; E04G 21/1891; E04G 17/14; G01B 5/143; G01B 5/16

(57) ABSTRACT

A metered track and stud framework erection method and system is disclosed. The system employs tracks which are metered to facilitate the rapid and accurate placement of studs between the tracks at equidistant spacing as required by conventional building codes and statutes. The studs are also metered or graduated, preferably in inches and centimeters, to facilitate the correct and appropriate placement of electrical outlets and plumbing avenues without costly errors. A method is disclosed for the proper use of the metered tracks and studs to efficiently and rapidly erect structure framework.

### CONTINUITY

This application is a non-provisional application of Provisional Patent Application No. 62/315,724, filed on Mar. 31, 2016, and priority is claimed thereto.

### FIELD OF THE PRESENT INVENTION

The present invention relates to construction mechanisms, and more specifically relates to a method for erecting track-based framing for a structure through the use of graduated stud beams, top tracks, and bottom tracks.

### BACKGROUND OF THE PRESENT INVENTION

Conventionally, structures are erected with a framework that includes tracks and studs. The tracks are disposed on the floor and ceiling to provide a seat or conduit for studs to be placed between the two tracks. The erection of such frameworks is standard practice for the construction of a wide variety of structures, including houses, business buildings, skyscrapers, and any other structure with internal walls.

Unfortunately, it can be difficult to erect structure framework rapidly and accurately, as each the top track and the bottom track for the frame must be first measured and marked in order to ensure correct stud placement between the tracks. If this is performed incorrectly, measurements will be off, and studs may be placed with improper spacing, causing violations of the building code. If measurements are not performed competently and accurately, a building inspector may force the construction team to rip out the framework, and redo it, unfortunately costing additional time and money to complete the project. If tracks and studs were pre-marked with graduated measurements, preferably in centimeters and/or inches, as well as with a colored, special stud marking matching the distance of regional building codes, accurate placement of studs can be accomplished quickly and easily, without the need for constant measuring.

Thus, there is a need for a new method by which structure framework may be erected that employs pre-marked tracks and studs, removing the need to manually measure the placement of each building component with a measuring tape prior to installation.

### SUMMARY OF THE PRESENT INVENTION

The present invention is a system and method for the construction of structure framing, such as the framing erected for the construction of a house, office building, or similar structure with internal walls. The method of the present invention employs a modified track and stud framing system equipped with graduated or metered markings and/or indentations configured to facilitate the rapid erection of structure framework in an accurate, measured position.

To restate, the present invention presents a better way to vertically place studs in the track because the tracks are pre-marked, and then additionally, the studs are pre-marked. Therefore, before the interior of the structure is dry-walled, the pre-marked studs and tracks make it very easy for electricians to know where to place electrical outlets, phone access terminals, and cable access ports. Similarly, plumbers are able to more quickly perform installations because they are able to measure the same height by sight between studs, rather than needing to measure manually with a measuring tape for each installation.

Since the studs are equipped with the graduated or metered markings, the electrical boxes within each of the erected wall frames will be uniform in height around the room, as opposed to conventionally installed electrical boxes, which are generally only roughly of the same height. This helps to prevent hasty or improperly installed electrical components, which could otherwise cause a building code violation. A large problem with contractors performing construction is that the often the distance present between installed studs is either too little or too large per building codes, forcing a reinstall of the frame work of the structure.

### BRIEF DESCRIPTION OF THE DRAWINGS

The present invention will be better understood with reference to the appended drawing sheets, wherein:

FIG. 1 exhibits a view of an end of the track of the present invention, equipped with metered markings/indentations.

FIG. 2 displays a enlarged close-up view of the top or bottom track used by the method of the present invention, disclosing the nature of the graduated or metered markings on the tracks.

FIG. 3 discloses a flow chart depicting the preferred method of the present invention to rapidly and accurately erect the framework of a structure with the metered studs and tracks.

### DETAILED DESCRIPTION OF THE PREFERRED EMBODIMENT

The present invention generally comprises studs (10) and tracks (20), each of which are equipped with a multitude of metered markings (30). The metered markings (30) may be in the form of imprinted or indented graduated markings molded into the metal of the tracks (20) and studs (10) of the framework of a structure. The metered markings (30) of the studs (10) are preferably delineated in centimeters and inches, and include specialized marks (40) to indicate ideal placement locations for electrical boxes, switches, water outlet, or other conventional inter-wall apparatus. The specialized marks (40) may be colored to help them stand out from the other metered markings (30), or may be deeper indented or imprinted into the metal of the stud (10), helping to further differentiate the markings. It is envisioned that the specialized markings (40) are largely consistent across most forms of building construction, however it should be understood that the specialized markings (40) may vary in placement according to the local building codes and customs of the region or country in which the construction takes place.

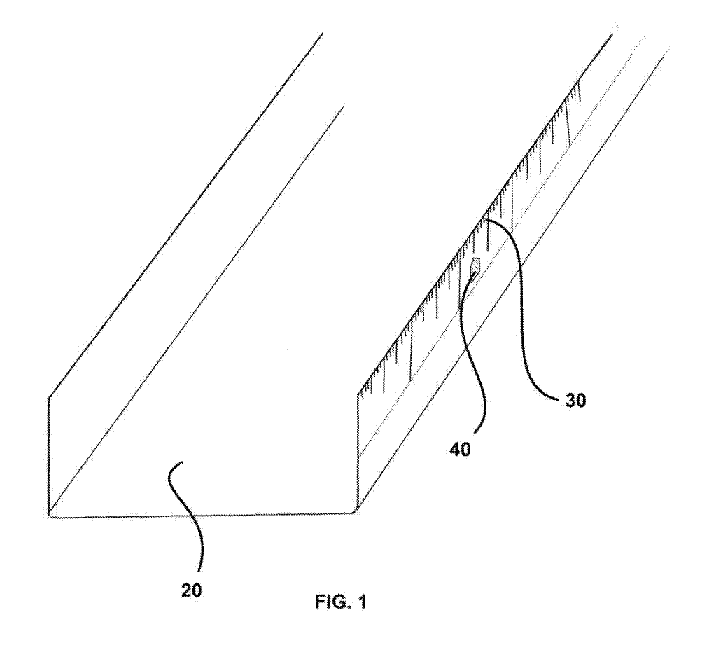

The metered markings (30) of the present invention are preferably disposed on the exterior portion of the tracks (20) and studs (10) as shown in FIG. 1. The metered markings (30) are preferably configured to extend laterally or horizontally across the tracks (20), and vertically down the studs (10) of the present invention. It should be understood that the metered markings (30) are preferably embedded or engraved in the structure of the tracks (20) and studs (10), however the metered markings (30) may be applied via a label displaying a tape measure form, or a stamp displaying a tape measure form in some embodiments of the present invention instead.

As shown in FIG. 1, the functionality of the studs (10) and tracks (20) is not altered, but rather the method by which they are erected is streamlined to expedite accurate placement of studs (10) within and between tracks (20) without the need for constant measuring with a metered measuring tape. The graduation in centimeters and inches is established via the metered markings (30) imprinted, marked, or embedded within the material of the studs (10) and tracks (20) of the present invention.

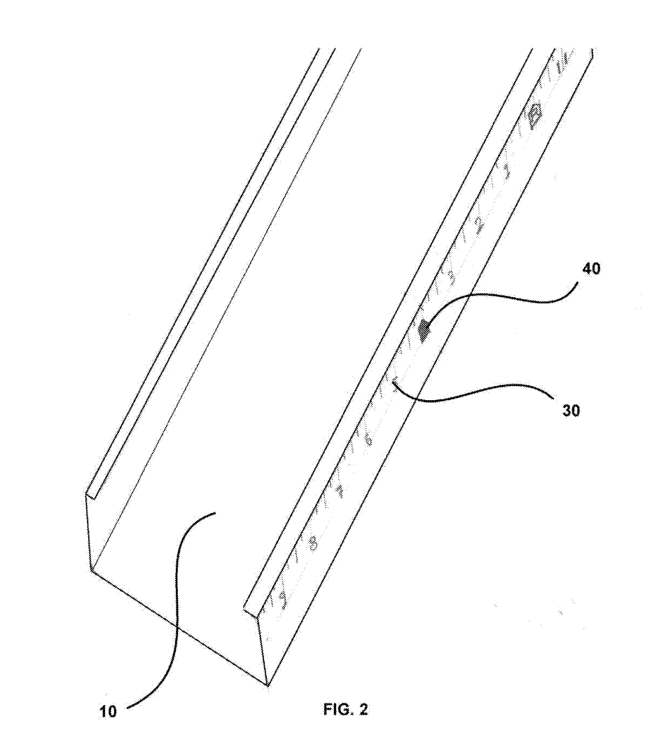

As seen in FIG. 2, the metered markings (30) of the tracks (20), both the top track and the bottom track of conventional framing, are preferably colored and/or indented into the metallic alloy material of the tracks (20). Ideally, the top track and the bottom track of the tracks (20) of the present invention are preferably positioned such that the metered markings (30) on the top track mirrors the metered markings (30) on the bottom track, as shown in FIG. 2. The specialized marks (40) depicted in FIG. 1 and FIG. 2 expedite the construction process, as each specialized mark (40) in the preferred embodiment of the present invention represents the placement of a stud into the track, which is preferably disposed at 16 inch increments. It is envisioned that in alternate embodiments of the present invention, the position of the specialized marks (40) may be disposed at increments higher or lower than 16 inches. In all embodiments, the incremental placement of the specialized marks (40) is individually consistent.

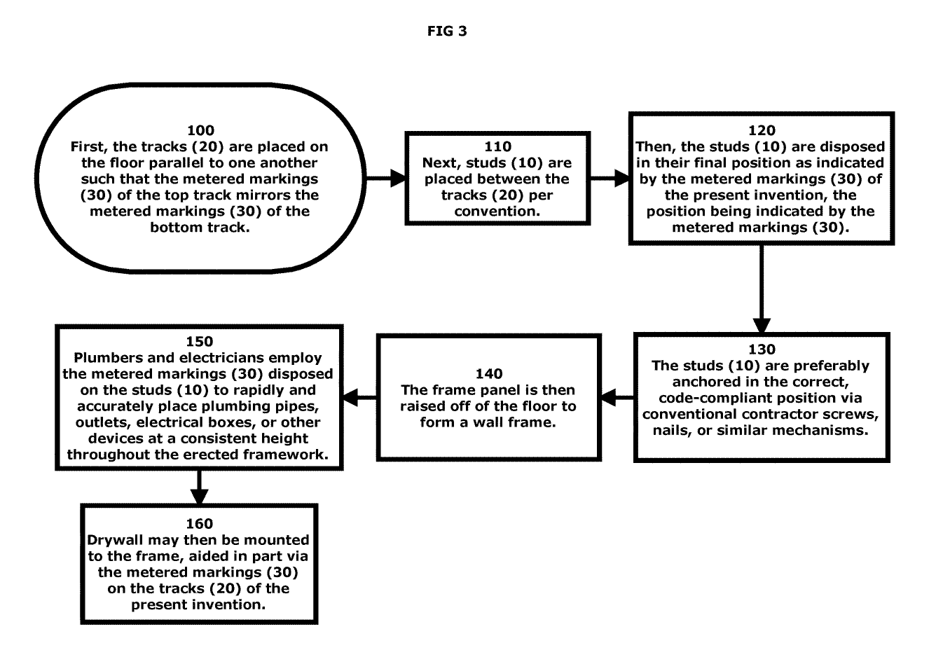

The method by which the framework of the structure is erected is largely conventional, with the exception of the time saved by removing the need to manually measure the placement of each individual stud (10) prior to permanent placement between the tracks (20). As shown in FIG. 3, the method of the present invention is best described as follows:

First, the tracks (20) are placed on the floor parallel to one another such that the metered markings (30) of the top track mirrors the metered markings (30) of the bottom track. (100) Next, studs (10) are placed between the tracks (20) per convention. (110) Then, the studs (10) are disposed (spaced appropriately) in their final position as indicated by the metered markings (30) of the present invention, the position being indicated by the metered markings (30). (120) The final position is dictated by local laws and regulations, however red markings are present within the metered markings (30) at increments of 16 inches, as the screws of drywall materials are 16 inches to place each stud per code. The studs (10) are preferably anchored in the correct, code-compliant position via conventional contractor screws, nails, or similar mechanisms. (130) The frame panel is then raised off of the floor to form a wall frame. (140) Plumbers and electricians employ the metered markings (30) disposed on the studs (10) to rapidly and accurately place plumbing pipes, outlets, electrical boxes, or other devices at a consistent height throughout the erected framework. (150) Drywall may then be mounted to the frame, aided in part via the metered markings (30) on the tracks (20) of the present invention. (160)

Alternate embodiments of the present invention may include a variation on the colors employed to highlight the metered markings (30) of the present invention. It is similarly envisioned that other metrics may be employed to delineate the metered markings (30) of the present invention, including specific markings to indicate where studs (10) should be placed between the tracks (20) for the proper construction of certain types of framework.

It should be understood that the tracks (20) of the present invention are equipped with track openings, which embody the channel-like nature of the tracks (20). The track openings are configured to accept the ends of the studs (10) when the studs (10) are placed perpendicularly into the track openings of the tracks (20). During initial construction, the tracks (20) are laid on the floor such that the track openings are facing one another, and such that the tracks (20) are parallel. Studs (10) are then placed in the track openings of the tracks (20) such that they are perpendicular to the plane of the tracks (20).

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An indoor wall erection method to be used by a contractor comprising:
placing a first track on a floor such that it is disposed on its side with an opening of the first track oriented away from the contractor;
placing a second track on the floor such that it is disposed on its side with an opening of the second track oriented towards the contractor;
wherein the first track and second track are parallel;
placing studs simultaneously within the first track and the second track such that they are perpendicular to the first track and the second track;
wherein the first track, the second track, and the studs are equipped with metered markings;
anchoring the studs in position within the first track and the second track such that they are spaced to be code-compliant per the metered markings, forming a frame panel; and
raising the frame panel such that it is perpendicular to the floor, forming a wall frame.

2. The method of claim 1, wherein the metered markings include red demarcations disposed at 16 inch intervals.

3. The method of claim 1, wherein the metered markings include black demarcations indicating a progression of inches.

4. The method of claim 1, wherein said anchoring the studs in position such that they are spaced to be code-compliant is achieved via contractor screws;

5. The method of claim 3, further comprising:
employing the black demarcations of the metered markings of the studs to accurately place plumbing pipes into code-compliant positions.

6. The method of claim 3, further comprising:
employing the black demarcations of the metered markings of the studs to accurately place electrical boxes at consistent heights throughout the wall frame such that the electrical boxes are code-compliant.

7. The method of claim 3, further comprising:
employing the metered markings of the studs to accurately place electrical outlets at consistent heights throughout the wall frame such that the electrical outlets are code-compliant.

8. The method of claim 5, further comprising:
mounting drywall to the first track and second track of the wall frame, aided by the metered markings, such that the drywall is level and cleanly cut.

9. The method of claim 8, wherein the metered markings are engraved.

10. The method of claim 8, wherein the metered markings are embossed.

11. A method for the construction of interior walls by a contractor comprising:
placing a first track on a floor such that it is disposed on its side with an opening of the first track oriented away from the contractor;
placing a second track on the floor such that it is disposed on its side with an opening of the second track oriented towards the contractor;
wherein the first track and second track are parallel;
placing studs simultaneously within the first track and the second track such that they are perpendicular to the first track and the second track;
wherein the first track, the second track, and the studs are equipped with metered markings;
wherein the metered markings are delineated in inches and feet;
wherein the metered markings include red marks disposed every 16 inches to facilitate code-appropriate spacing of studs;
wherein the metered markings include black demarcations indicating a progression of inches;
spacing the studs 16 inches apart, aided by the red marks of the metered markings;
anchoring the studs to the first track and the second track with screws, forming a frame panel;
raising the frame panel such that it is perpendicular to the floor, forming a wall frame;
anchoring drywall panels to the wall frame;
employing the black demarcations of the metered markings of the studs to accurately place plumbing pipes into code-compliant positions;
employing the black demarcations of the metered markings of the studs to accurately place electrical boxes at consistent heights throughout the wall frame such that the electrical boxes are code-compliant; and
employing the metered markings of the studs to accurately place electrical outlets at consistent heights throughout the wall frame such that the electrical outlets are code-compliant.

12. The method of claim 11, wherein the red marks of the metered markings are embossed.

13. The method of claim 11, wherein the metered markings are engraved into the studs, the first track and the second track.
